(19) United States
(12) Patent Application Publication
(10) Pub. No.: US 2011/0180446 A1
(43) Pub. Date: Jul. 28, 2011

(54) CONTAINER FOR PRODUCE STORAGE, PACKING & TRANSPORT

(75) Inventors: Allen Kidd, Placentia, CA (US); Stephen P. Zapatka, Kingston, IL (US)

(73) Assignee: PENINSULA PACKAGING, LLC, Exeter, CA (US)

(21) Appl. No.: 12/696,036

(22) Filed: Jan. 28, 2010

(51) Int. Cl. B65D 21/032; B65D 6/00; B65D 8/04; B23P 19/04

(52) U.S. Cl. 206/509; 220/4.22; 220/4.25; 29/700

(57) ABSTRACT

Embodiments are directed to containers having a bottom and top hingedly connected together on at least one edge. When the container is viewed in an open configuration, the bottom and top may each include a plurality of receptacles in one or more rows of linear arrays. The receptacles in both the top and bottom may correspond to one another and may define an enclosure when the container is in a closed configuration. In some embodiments, the enclosure is orb-like in configuration for enclosing individual food items. When the container is viewed in a closed configuration, each receptacle may define an apex or antipodal point on an outer surface thereof wherein each apex/antipodal point includes a receiving protrusion or an insertion protrusion. When containers are stacked together, each insertion protrusion from one container may reversibly engage with a corresponding receiving protrusion from another container resulting in a stacked array of containers.

### FIELD

The present invention relates to the field of containers, in particular, to containers having stacking mechanisms for bulk stacking.

### BACKGROUND

It is common to use clear hinged containers to transport and package fresh and chilled foods, such as fruit, for selling to consumers. The containers allow the food to be transported with less damage, such as bruising, and provide convenient packaging for consumers who are purchasing the food. Although convenient for the consumer, these types of containers often pose certain problems from a manufacturer's perspective. One such problem is the ability of such containers to stack for transportation purposes. Bulk shipment of many of these containers in large shipping boxes is the only way to economically transport and deliver adequate supplies of food (e.g., fruit) to the retailer. However, in view of the construction of many conventional containers, the ability to fully pack a shipping box is often not possible. Conventional containers are independent of one another and cannot generally provide support to other containers within the same shipping box. As a result, the containers are likely to shift throughout transport causing damage to the contents therein. Moreover, much care must generally be taken when filling a shipping box due to the delicate construction of conventional containers. This directly translates into increased labor costs and/or damage to the food item packaged therein.

Consequently, a container which alleviates the problems associated with prior art containers is needed.

### SUMMARY

The following presents a simplified summary of one or more embodiments in order to provide a basic understanding of some embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

A container, comprising: a bottom having a periphery defined by four edges, the bottom having a plurality of bottom receptacles in an array; a top having a periphery defined by four edges and hingedly connected to the bottom at one edge, the top piece having a plurality of top receptacles in an array; at least one insertion protrusion on at least one top receptacle; and at least one receiving protrusion on at least one bottom receptacle wherein the receiving protrusion is sized to receive the insertion protrusion is herein disclosed.

In a closed position, the plurality of bottom receptacles may correspond to the plurality of top receptacles, each bottom receptacle and corresponding top receptacle forming an enclosure. Each enclosure may define an orb-like configuration. Each bottom receptacle may be separated from at least one adjacent bottom receptacle by an upwardly extending spacial divider wherein an apex of the spacial divider is substantially flat. Each apex of each spacial divider may include a protrusion centered thereof. Each top receptacle may be separated from at least one adjacent top receptacle by a downwardly extending spacial divider wherein an apex of the spacial divider is substantially flat. Each apex of each spacial divider may include an opening centered thereon.

In a closed position, each opening may receive a corresponding protrusion. In some embodiments, (i) the bottom receptacles are in at least two rows, each row a linear array, and (ii) the top receptacles are in at least two rows, each row a linear array. In some embodiments, (i) each bottom receptacle defines an apex on an outer surface thereon and (ii) each top receptacle defines an apex on an outer surface thereon. In some embodiments, (i) a receiving protrusion is situated on the apex of each bottom receptacle defining a corner of the bottom and (ii) an insertion protrusion is situated on the apex of each top receptacle defining a corner of the top. In some embodiments, (i) each insertion protrusion is adapted to reversibly engage with a corresponding receiving protrusion of another container stacked thereon and (ii) each receiving protrusion is adapted to reversibly engage with a corresponding insertion protrusion of another container stacked thereunder.

The periphery of the bottom may define a bottom flange, the bottom flange having a plurality of openings symmetrically spaced thereabout. Similarly, the periphery of the top may define a top flange, the top flange having a plurality of protrusions symmetrically spaced thereabout and corresponding to the plurality of openings. In a closed configuration, the plurality of openings may engage with the plurality of protrusion providing a gap between the top flange and the bottom flange.

A stacked container configuration, comprising: a first container having (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) at least one insertion protrusion on at least one top receptacle; and a second container having (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) at least one receiving protrusion on at least one bottom receptacle wherein the insertion protrusion of the first container is reversibly engaged with the receiving protrusion of the second container is herein disclosed.

The stacked container configuration of claim 15 wherein the first container further comprises at least one receiving protrusion on at least one bottom receptacle, the at least one receiving protrusion reversibly engaged with an insertion protrusion of a third container, the third container comprising (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) the at least one insertion protrusion on at least one top receptacle.

The second container may further comprise at least one insertion protrusion on at least one bottom receptacle, the at least one insertion protrusion reversibly engaged with a receiving protrusion of a fourth container, the fourth container comprising (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) the at least one insertion protrusion on at least one top receptacle.

A method of stacking containers, comprising: placing a first container in a closed configuration within a box, the first container having at least one insertion protrusion on at least one top receptacle of a top of the first container; placing a second container in a closed configuration on the first container, the second container having at least one receiving protrusion on at least one bottom receptacle of a bottom of the second container; and engaging the insertion protrusion of the first container with the receiving protrusion of the second container is herein disclosed. The method may further comprise repeating the placing of subsequent containers in a closed configuration until a stacked container configuration is formed. The stacked container configuration may be substantially rigid when pressure is applied thereto.

### BRIEF DESCRIPTION OF THE DRAWINGS

FIG. 1 illustrates a perspective view of an interior of a container in an open configuration according to an embodiment of the invention.

FIG. 2 illustrates a perspective view of an exterior of the container in FIG. 1 in an open configuration.

FIG. 3 illustrates a perspective view of a bottom of the container in FIG. 1 in a closed configuration.

FIG. 4 illustrates a perspective view of a top of the container in FIG. 1 in a closed configuration.

FIG. 5 illustrates a side view of the container in FIG. 1 in a closed configuration and stacked on another container according to embodiments of the invention.

FIG. 6 illustrates a cross-sectional view of a “stacking mechanism” of two stacked containers according to embodiments of the invention.

FIG. 7 illustrates a plurality of containers according to embodiments of the invention in a stacked configuration in a transportation box and at least one container being positioned therein.

### DETAILED DESCRIPTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In the following description, certain terminology is used to describe certain features of one or more embodiments of the invention. The term “container” refers to any type of device for holding objects, including a receptacle, a bin, a box, a carton, a case, and a crate. The term “food” refers to any type of edible substance including all types of fruits and vegetables.

Embodiments of the invention are directed to containers having a bottom and a top hingedly connected together on at least one edge, respectively. When the container is viewed in an open configuration, the bottom and the top may each include a plurality of receptacles in one or more rows of linear arrays. The receptacles in both the top and bottom may correspond to one another and may define an enclosure when the container is in a closed configuration. In some embodiments, the enclosure is orb-like in configuration and capable of enclosing an individual food item. When the container is viewed in a closed configuration, each receptacle may define an apex or antipodal point on an outer surface thereof wherein one or more of the apex/antipodal points may include either a receiving protrusion or an insertion protrusion. When two or more containers according to embodiments of the invention are stacked together, each insertion protrusion from one container may reversibly engage with a corresponding receiving protrusion from another container resulting in a stacked array of containers.

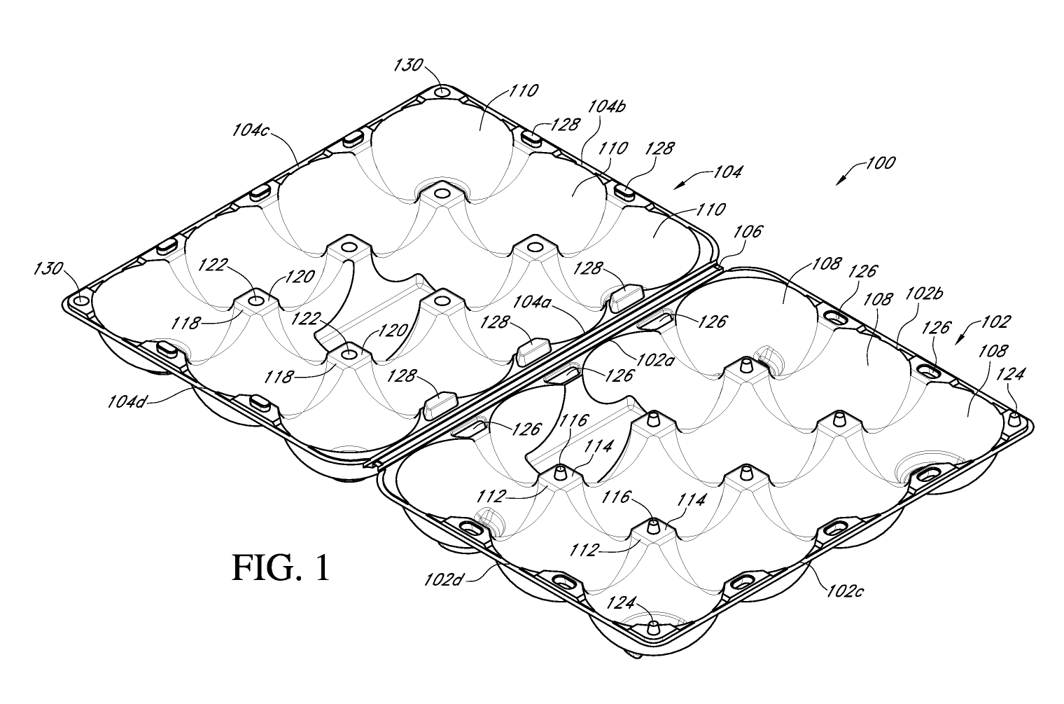

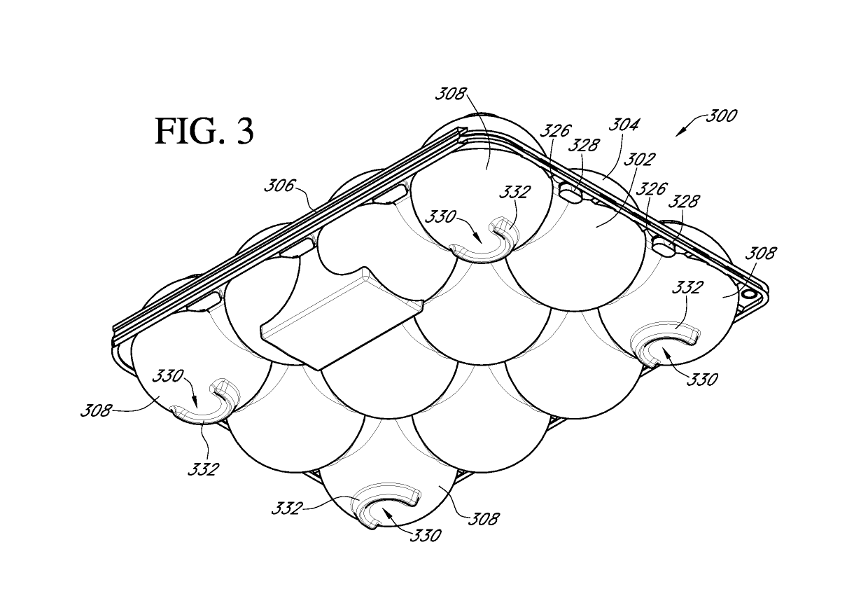

FIG. 1 illustrates a perspective view of an interior of a container in an open configuration according to an embodiment of the invention. As shown, a container 100 includes a bottom 102 connected to a top 104 via a hinge 106. In the context of this application, “open configuration” means that the bottom and the top are positioned approximately 180° relative to one another at the hinge; however, one of ordinary skill in the art will appreciate that the container according to embodiments of the invention may be opened within the range of 180°, in some cases, more than 180°. The bottom 102 includes a plurality of individual bottom receptacles 108 in one or more rows of linear arrays; however, alternative arrays such as staggered, circular or semicircular arrays are within the scope of the invention. Similarly, the top 104 includes a plurality of individual top receptacles 110 in one or more rows of linear arrays; however, alternative arrays such as staggered, circular or semicircular arrays are within the scope of the invention. According to embodiments of the invention, the linear arrays of the bottom receptacles 108 correspond to the linear arrays of the top receptacles 110 forming an enclosure when the container 100 is in a closed configuration (see FIGS. 3-5, explained in more detail below). As shown in the embodiment illustrated in FIG. 1, the number of bottom receptacles 108 and corresponding top receptacles 110 number twelve (12) in three (3) rows of linear arrays; however, any number of receptacles in any array is within the scope of the invention.

Each bottom receptacle 108 may be separated from one or more adjacent bottom receptacles 108 by an upwardly extending spacial divider 112 (“upwardly” relative to the container 100 in a closed configuration). Each spacial divider 112 may terminate in a substantially flat apex 114 with a protrusion 116 centered thereon. Similarly, each top receptacle 110 may be separated from one or more adjacent top receptacles 110 by a downwardly extending spacial divider 118 (“downwardly” relative to the container 100 in a closed configuration). Each spacial divider 118 may terminate in a substantially flat apex 120 with an opening 122 centered thereon. When the container 100 is in a closed configuration, each protrusion 116 may reversibly engage (i.e., latch) with each corresponding opening 122. In this aspect, when engaged, the spacial dividers 112, 118 function as stiffeners when food is packed within each individual receptacle in the container 100. This stiffening function prevents the container 100 from deflecting and pulling itself apart when the container 100 is fully packed. Moreover, in view of that the spacial dividers 112, 118 are aligned when engaged, this alignment feature partially, substantially or completely prevents the container 100 from twisting when handled by a user. Alternative configurations of spacial dividers, e.g., continuous walls, are within the scope of the invention.

The bottom 102 may be defined by four edges 102a, 102b, 102c and 102d while the top 104 may similarly be defined by four edges 104a, 104b, 104c and 104d. Each of the edges 102a, 102b, 102c and 102d may define a flange with one or more protrusions 124 and/or openings 126 symmetrically spaced thereabout. Similarly, each of the edges 104a, 104b, 104c and 104d may define a flange with one or more protrusions 128 and/or openings 130 symmetrically spaced thereabout. If the flange of the bottom 102 includes one or more openings 126 symmetrically spaced thereabout, the flange of the top 104 includes one or more corresponding protrusions 128 symmetrically spaced thereabout. Similarly, if the flange of the bottom 102 includes one or more protrusions 124 symmetrically spaced thereabout, the flange of the top 104 includes one or more corresponding openings 130 symmetrically spaced thereabout. When the container 100 is in a closed configuration (see FIGS. 3-5), the openings 126 reversibly engage with the corresponding protrusions 128 and, additionally, the protrusions 124 reversibly engage with the corresponding openings 130. Thus, the openings 126 are sized to receive the corresponding protrusions 128, while the openings 130 are sized to receive the corresponding protrusions 124. In the embodiment shown in FIG. 1, the flange of the bottom 102 principally includes openings 126 symmetrically spaced thereabout with two (2) protrusions 124 on the outermost corners. Consequently, the flange of the top 104 principally includes corresponding protrusions 128 symmetrically spaced thereabout with two (2) openings 130 on the outermost corners.

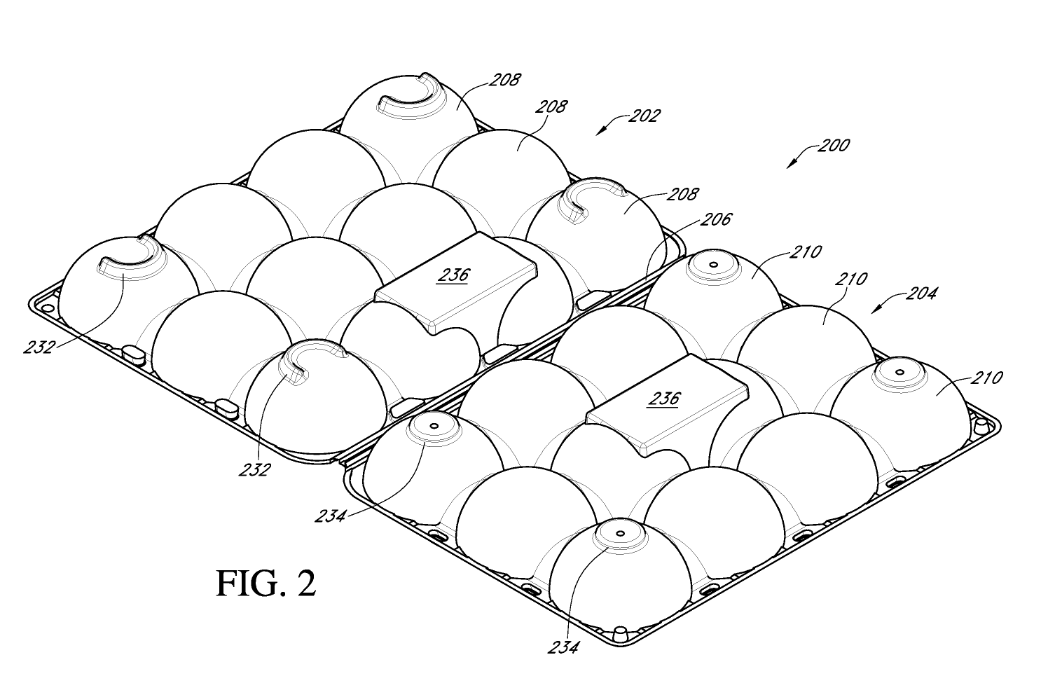

FIG. 2 illustrates a perspective view of an exterior of the container in FIG. 1 in an open configuration. As shown, FIG. 2 illustrates the container 200 with the bottom 202 connected to the top 204 by the hinge 206. An exterior of the plurality of bottom receptacles 208 of the bottom 202 is also shown as is an exterior of the plurality of top receptacles 210 of the top 204. The receptacles 208, 210 appear as “receptacles” when viewing an interior of a container according to embodiments of the invention in an open configuration, but appear as “protrusions” when viewing an exterior of the same container; however, one of ordinary skill in the art will appreciate that a “receptacle” when viewing the interior of the container is the same as the “protrusion” when viewing the exterior of that same container. According to embodiments of the invention, both of the exteriors of the bottom receptacles 208 and the top receptacles 210 may define an apex or an antipodal point. In other words, the apex or the antipodal point is the furthest point of each receptacle 208, 210 from the center of a plane bisecting the greatest diameter of each receptacle 208, 210.

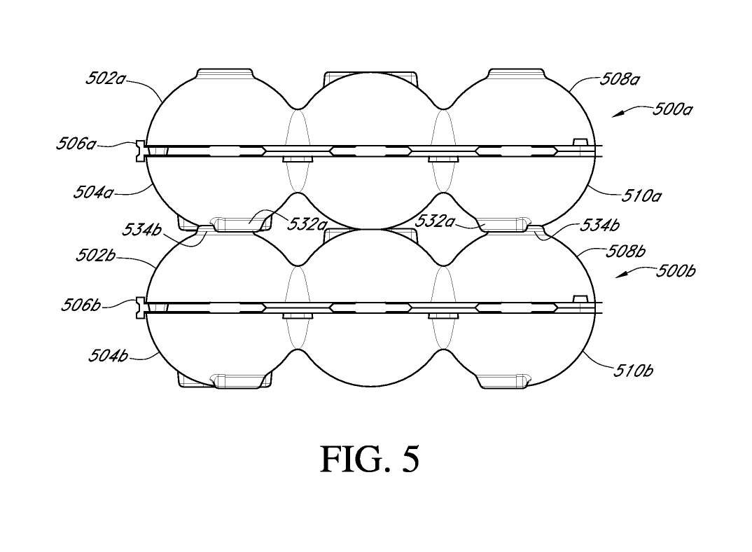

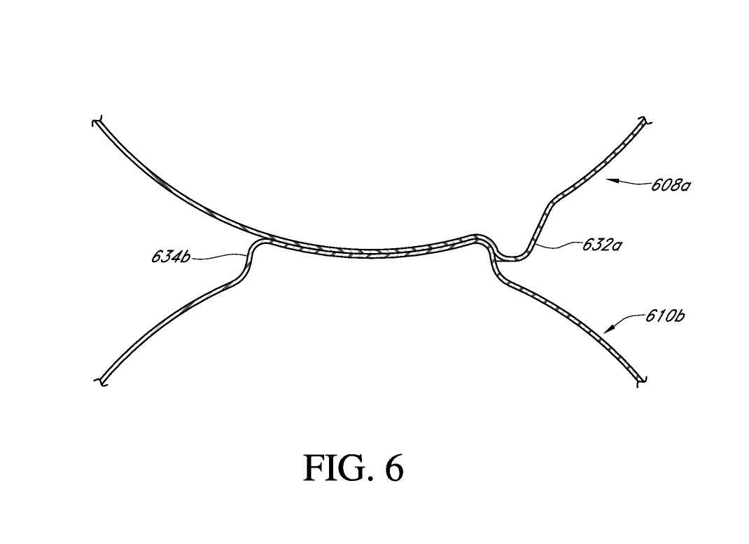

According to embodiments of the invention, one or more receiving protrusions 232 may be located at the apex (or antipodal point) of any bottom receptacle or receptacles 208. Similarly, one or more insertion protrusions 234 may be located at the apex (or antipodal point) of any top receptacle or receptacles 210. Each receiving protrusion 232 may be sized to receive a corresponding insertion protrusion 234 when the container 200 is stacked under, or stacked on, another container configured according to embodiments of the invention (see FIGS. 5-6, explained in more detail below). According to embodiments of the invention, the receiving protrusions 232 may be located on each of the corner-most bottom receptacles 208 of the bottom 202. Likewise, the insertion protrusions 234 may be located on each of the corner-most top receptacles 210 of the top 204. In this respect, a set of receiving protrusions of one container may correspond to a set of insertion protrusions of another container underneath, while a set of insertion protrusions of the container may correspond to a set of receiving protrusions of another different container above, and so on and so forth. As shown in FIG. 2, the receiving protrusions 232 are horseshoe-shaped and the insertion protrusions 234 are circular-shaped; however, in any embodiment, the receiving and insertion protrusions should be able fit, slide and/or snap together, i.e., the receiving protrusion should be a female part while the insertion protrusion should be a corresponding male part. In that regard, the receiving protrusion may be half a square, part of a triangle, etc. while the male protrusion may be a corresponding square, triangle, etc. In the embodiment shown in FIG. 2, four (4) receiving protrusion 232 are shown positioned on each of the corner-most bottom receptacles 208 while four (4) insertion protrusions 234 are shown on each of the corner-most top receptacles 210.

As described previously, the receptacles 208, 210 appear as “protrusions” in the exterior view of the container 200 as shown in FIG. 2. Thus, when viewed exteriorly, the container 200 includes interstitial spaces between each receptacle/protrusion 208, 210. According to embodiments of the invention, a pedestal 236 may be nestled within one of the interstitial spaces. The pedestal 236 may function to steady a plurality of containers configured according to embodiments of the invention when stacked together. The pedestal 236 may also function as a location on the container to place labels, for example a universal product code (UPC) label or any other type of branding label, embossing or debossing.

FIG. 3 illustrates a perspective view of a bottom of the container in FIG. 1 in a closed configuration. As shown, FIG. 3 illustrates the container 300 with the bottom 302 connected to the top 304 by the hinge 306. In the closed configuration, the flange of the bottom 302 is substantially adjacent to the flange of the top 304; however, the respective flanges are not in direct contact. Instead, when the container 300 is in a closed configuration, the openings 326 (of bottom 302) reversibly engage with the corresponding protrusions 328 (of top 304) and, additionally, the bottom protrusions (of bottom 302, not shown, see reference number 124 of FIG. 1) reversibly lock with the corresponding top openings (of top 304, not shown, see reference number 130 of FIG. 1) creating a gap between the respective flanges. In combination with the hinge 306, the “locks” created by openings 326 engaged with protrusions 328 and the bottom protrusions paired with the top openings (not shown, see reference numbers 124 and 130 of FIG. 1) become part of the overall support mechanism of the container 300 which allows air to circulate within the container. As a result, food, e.g., fruits/vegetables, stored therein remain fresher longer. Also, this feature alleviates having to punch holes throughout the container which may otherwise result in additional manufacturing costs.

Also shown in FIG. 3 are four receiving protrusions 332 situated at the apex or antipodal point of the corner-most bottom receptacles 308. According to the embodiment shown, the receiving protrusion 332 is horseshoe-shaped. As shown, an opening 330 of each receiving protrusion 332 faces outwardly relative to a center of the bottom 302. This feature allows a set of corresponding insertion protrusion (not shown) on another container to reversibly engage therewith in order to facilitate and stabilize a plurality of stacked containers.

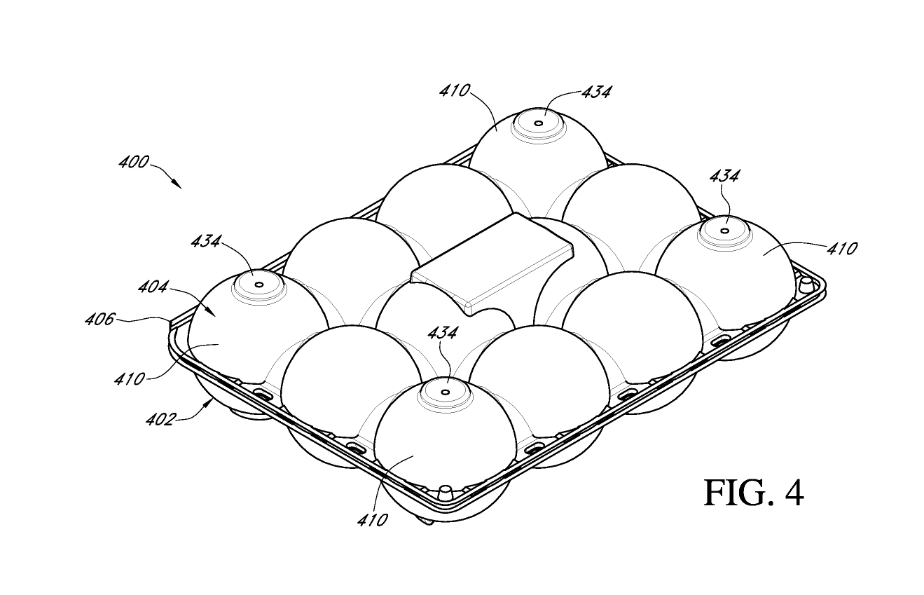

FIG. 4 illustrates a perspective view of a top of the container in FIG. 1 in a closed configuration. As shown, FIG. 4 illustrates the container 400 with the bottom 402 connected to the top 404 by the hinge 406. Also shown in FIG. 4 are four insertion protrusions 434 situated at the apex or antipodal point of the corner-most top receptacles 410. According to the embodiment shown, the insertion protrusion 434 is circular-shaped. As described previously, the insertion protrusion 434 is sized to fit, slide and/or snap into a set of corresponding receiving protrusions (not shown) another container to reversibly engage therewith in order to facilitate and stabilize a plurality of stacked containers. The containers according to embodiments of the invention may be of a material such as, but not limited to, polyethylene terephthalate (PET), polystyrene or polypropylene.

FIG. 5 illustrates a side view of the container in FIG. 1 in a closed configuration and stacked on another container according to embodiments of the invention. As shown, FIG. 5 illustrates the container 500a stacked on another container 500b. The containers 500a, 500b each include a bottom 504a, 504b connected to a top 502a, 502b by a hinge 506a, 506b, respectively. Additionally, each container 500a, 500b includes a plurality of top receptacles 508a, 508b and a plurality of bottom receptacles 510a, 510b brought together to form a plurality of enclosures. FIG. 5 also illustrates the “stacking mechanism” of one or more receiving protrusions 532a (of container 500a) with one or more insertion protrusions 534b (of container 500b). As described previously, the insertion protrusions 534b of container 500b are sized to fit, slide and/or snap into a set of corresponding receiving protrusions 532a of container 500a to reversibly engage therewith in order to facilitate and stabilize a plurality of stacked containers.

FIG. 6 illustrates a cross-sectional view of a “stacking mechanism” of two receptacles of two stacked containers according to embodiments of the invention. As shown, an insertion protrusion 634b of a top receptacle 610b of a container (not shown) is slidably engaged with a receiving protrusion 632a of a bottom receptacle 608a (not shown) of another container (not shown). Advantageously, the containers stack together by the physical engagement of the “stacking mechanism” thereby providing stability to the containers during shipment. Thus, in addition to the individual enclosures housing individual pieces of fruit and/or vegetables which may be particularly sensitive to damage and bruising, the “stacking mechanism” provides another layer of protection to the fruits/vegetables during packing and transport.

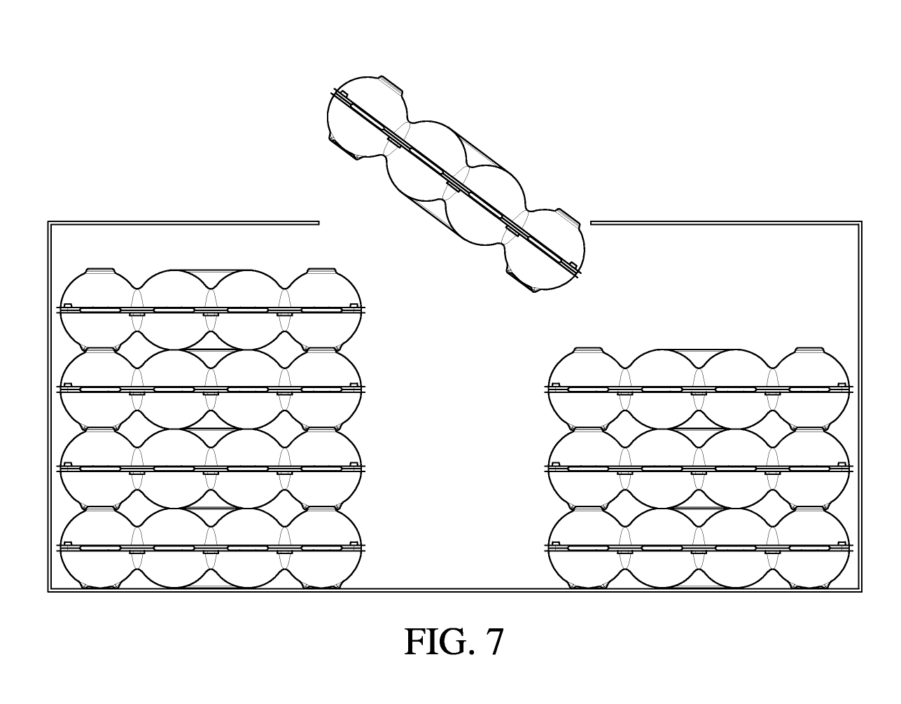

FIG. 7 illustrates a plurality of containers according to embodiments of the invention in a stacked configuration in a transportation box and at least one container being positioned therein. When containers according to embodiments of the invention are packed into a shipping box, the “stacking mechanism”, i.e., the coupling or engagement of insertion protrusions (of one container) with/to receiving protrusions (of another container), allow the packer to completely or substantially completely fill the shipping box. That is, when a container is packed into the shipping box, each container is tilted sideways so that it can fit in and over an opening in the shipping box. In view of the individual enclosures housing individual pieces of fruit/vegetables combined with the “stacking mechanism” feature of the containers according to embodiments of the invention, the individual pieces of fruit/vegetables are protected in multiple ways. Additionally, the resulting stacked configuration allows the retailer to merchandise the containers in the shipping box without having to unload individual containers thereby allowing consumers to pull out individual containers. This feature results in significant labor costs associated with unloading individual containers.

One or more of the components and functions illustrated in the previous figures may be rearranged and/or combined into a single component or embodied in several components without departing from the invention. Additional elements or components may also be added without departing from the invention.

While certain exemplary embodiments have been described and shown in the accompanying drawings, it is to be understood that such embodiments are merely illustrative of and not restrictive on the broad invention, and that this invention is not be limited to the specific constructions and arrangements shown and described, since various other modifications may occur to those ordinarily skilled in the art.

1. A container, comprising:
a bottom having a periphery defined by four edges, the bottom having a plurality of bottom receptacles in an array;
a top having a periphery defined by four edges and hingedly connected to the bottom at one edge, the top piece having a plurality of top receptacles in an array;
at least one insertion protrusion on at least one top receptacle; and
at least one receiving protrusion on at least one bottom receptacle wherein the receiving protrusion is sized to receive the insertion protrusion.

2. The container of claim 1 wherein, in a closed position, the plurality of bottom receptacles correspond to the plurality of top receptacles, each bottom receptacle and corresponding top receptacle forming an enclosure.

3. The container of claim 2 wherein each enclosure defines an orb-like configuration.

4. The container of claim 3 wherein each bottom receptacle is separated from at least one adjacent bottom receptacle by an upwardly extending spacial divider wherein an apex of the spacial divider is substantially flat.

5. The container of claim 4 wherein each apex of each spacial divider includes a protrusion centered thereon.

6. The container of claim 5 wherein each top receptacle is separated from at least one adjacent top receptacle by a downwardly extending spacial divider wherein an apex of the spacial divider is substantially flat.

7. The container of claim 6 wherein each apex of each spacial divider includes an opening centered thereon.

8. The container of claim 7 wherein, in a closed position, each opening to receive a corresponding protrusion.

9. The container of claim 1 wherein (i) the bottom receptacles are in at least two rows, each row a linear array, and (ii) the top receptacles are in at least two rows, each row a linear array.

10. The container of claim 9 wherein (i) each bottom receptacle defines an apex on an outer surface thereon and (ii) each top receptacle defines an apex on an outer surface thereon.

11. The container of claim 10 wherein (i) a receiving protrusion is situated on the apex of each bottom receptacle defining a corner of the bottom and (ii) an insertion protrusion is situated on the apex of each top receptacle defining a corner of the top.

12. The container of claim 11 wherein (i) each insertion protrusion is adapted to reversibly engage with a corresponding receiving protrusion of another container stacked thereon and (ii) each receiving protrusion is adapted to reversibly engage with a corresponding insertion protrusion of another container stacked thereunder.

13. The container of claim 1 wherein the periphery of the bottom defines a bottom flange, the bottom flange having a plurality of openings symmetrically spaced thereabout, and wherein the periphery of the top defines a top flange, the top flange having a plurality of protrusions symmetrically spaced thereabout and corresponding to the plurality of openings.

14. The container of claim 13 where, in a closed configuration, the plurality of openings engage with the plurality of protrusion providing a gap between the top flange and the bottom flange.

15. A stacked container configuration, comprising:
a first container having (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) at least one insertion protrusion on at least one top receptacle; and
a second container having (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) at least one receiving protrusion on at least one bottom receptacle wherein the insertion protrusion of the first container is reversibly engaged with the receiving protrusion of the second container.

16. The stacked container configuration of claim 15 wherein the first container further comprises at least one receiving protrusion on at least one bottom receptacle, the at least one receiving protrusion reversibly engaged with an insertion protrusion of a third container, the third container comprising (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) the at least one insertion protrusion on at least one top receptacle.

17. The stacked container configuration of claim 15 wherein the second container further comprises at least one insertion protrusion on at least one bottom receptacle, the at least one insertion protrusion reversibly engaged with a receiving protrusion of a fourth container, the fourth container comprising (i) a bottom having a periphery defined by four edges, the bottom having a plurality of bottom receptacles in an array; (ii) a top having a periphery defined by four edges and hingedly connected to the bottom at one edge, the top piece having a plurality of top receptacles in an array; and (iii) the at least one insertion protrusion on at least one top receptacle.

18. A method of stacking containers, comprising:
placing a first container in a closed configuration within a box, the first container having at least one insertion protrusion on at least one top receptacle of a top of the first container;
placing a second container in a closed configuration on the first container, the second container having at least one receiving protrusion on at least one bottom receptacle of a bottom of the second container; and
engaging the insertion protrusion of the first container with the receiving protrusion of the second container.

19. The method of claim 18, further comprising, repeating the placing of subsequent containers in a closed configuration until a stacked container configuration is formed.

20. The method of claim 19 wherein the stacked container configuration is substantially rigid when pressure is applied thereto.
